(19) United States
(12) Patent Application Publication
(10) Pub. No.: US 2024/0193236 A1
(43) Pub. Date: Jun. 13, 2024

(54) METHODS AND SYSTEMS OF SECURELY SHARING DATA

(71) Applicant: SCIENCE & ENGINEERING APPLICATIONS LTD., Rhoscolyn Anglesey Holyhead Gwynedd (GB)

(72) Inventors: David HUNNISETT, RACHUB (GB); James INGRAM, RHOSCOLYN (GB)

(21) Appl. No.: 18/285,219

(22) PCT Filed: Mar. 29, 2022
(86) PCT No.: PCT/IB2022/052901

§ 371 Date: Sep. 29, 2023

(30) Foreign Application Priority Data
Mar. 29, 2021 (GB) 2104456.5

(51) Int. Cl. G06F 21/31; G06F 21/45

(52) U.S. Cl. CPC G06F 21/31; G06F 21/45

(57) ABSTRACT

A computer implemented method for securely sharing underlying data of a data owner to a data recipient is disclosed. In an embodiment said method comprises the steps of providing access to underlying data to a sharing intermediary; providing personalised data confidence information to the sharing intermediary; storing said underlying data and said personalised data confidence information at the sharing intermediary, supplying a data passphrase generated by the sharing intermediary to the data owner that uniquely identifies said underlying data; supplying the data passphrase and the data confidence information to the data recipient; providing the data passphrase and the data confidence information to the sharing intermediary; checking whether the data passphrase is associated with stored underlying data; and supplying the underlying data from the sharing intermediary to the data recipient if the data confidence information matches the personalised data confidence information associated with the underlying data.

### FIELD

The disclosure relates to methods and systems of securely sharing data. In particular to securely sharing data of a data owner to a data recipient.

### BACKGROUND

Data sharing is becoming an increasingly difficult issue, particularly when medical or financial data of a user needs to be transferred from a data owner to a data recipient. As an example, in response to the coronavirus disease (COVID 2019) caused by the severe acute respiratory syndrome coronavirus 2 virus (SARS-COV2) health apps were launched by local and national health authorities for the self-monitoring of health symptoms by the public. However, these apps are not linked to a patient's medical records, and many users are concerned by the risks associated with transferring identifiable health data.

Additionally, devices such as the Apple Watch™ allow a user to collect medical data, such as activity levels and electrocardiograms that may require sending to a medical practioner.

Similarly, financial records may also be collated by many apps and it may be beneficial for a user to share some of this data to a third party in a semi-anonymous manner.

Whilst one-time generated links provide a means for establishing such handshakes, these are typically only suitable where there exists a mechanism for lossless communication (such as SMS or email) between the data holder and data recipient. This option is not available over a phone line or when the recipient does not wish to give personal details (phone number or email address) to the data sender.

It is an aim of the present invention to address or at least ameliorate the above issues.

### SUMMARY

According to a first aspect there is provided a computer implemented method for securely sharing underlying data of a data owner to a data recipient, said method comprising the steps of providing access to the underlying data of the data owner to a sharing intermediary; providing personalised data confidence information from the data owner to the sharing intermediary; storing said underlying data and said personalised data confidence information at the sharing intermediary, wherein the personalised data confidence information is associated with the underlying data; supplying a data passphrase generated by the sharing intermediary to the data owner, said data passphrase uniquely identifying said underlying data; supplying the data passphrase and the data confidence information from the data owner to the data recipient; providing the data passphrase and the data confidence information from the data recipient to the sharing intermediary; checking, by the sharing intermediary, whether the data passphrase is associated with stored underlying data; and supplying the underlying data from the sharing intermediary to the data recipient if the data confidence information matches the personalised data confidence information associated with the underlying data.

The present invention provides a secure method and system of transferring underlying data from a data owner to a data recipient using a sharing intermediary. The use of a sharing intermediary allows the data owner to authorise data transfer if they trust the data recipient (by providing the data recipient with the passcode and authentication information). The data owner does not need to be a securely registered user of the sharing intermediary—they do not need to trust the sharing intermediary.

The step of providing access to the underlying data of the data owner to a sharing intermediary may further comprise the step of providing data filters, said data filters filtering said underlying data of the data owner provided to the sharing intermediary. The data filters can allow a data owner to select which data is to be shared. The data filters may be additional information filters provided by the data owner in addition to system or base filters that apply to known metadata in the system and to known personally identifying information such as names, addresses, phone numbers, etc. already known to the data recipient in a database or data dictionary.

In an embodiment, there may be a step of providing a preview of the filtered underlying data to the data owner. Optionally or preferably this step may occur prior to providing said filtered underlying data to the sharing intermediary

Advantageously, the step of providing access to the underlying data of the data owner may further comprise the step of anonymising the underlying data prior to providing access to the sharing intermediary.

The step of providing access to the underlying data of the data owner may further comprise the step of setting access limits on the underlying data. For example, this may include only allowing the information to be accessed a certain number of times, or may include the use of differing passcodes and/or data confidence information for different levels or amounts of underlying data.

The method may further comprise the step of identifying the data recipient accessing the underlying data. A step of logging said identifier information against said underlying data after accessing said data may be used to log said data access.

The method may comprise a step of supplying a local identifier of the data recipient for the underlying data to the intermediary sender. A step of tagging said underlying data with the data recipient's local identifier may also be undertaken.

In an embodiment the step of providing access to the underlying data of the data owner to a sharing intermediary may further comprise the step of receiving an additional data filter from the data recipient, such that only underlying data corresponding to the additional data filter is supplied to the data recipient. It may be appreciated that this filter may be akin to the filtering described above, or may be additional filtering.

Said filtering may be applied at the point of access of the underlying data to the data recipient. Where filtering has already occurred, if the underlying data has been updated since creation of the previous filter the recipient will obtain the latest information and not just the data at the time of initiation of the data sharing process.

Additionally, where the additional filtering occurs, this may occur after the system or base filters. An artificial intelligence (AI) filter may be applied to remove any third party personally identifying information contained with free text data. Examples of such information may include the name and address of the health practitioner accessing the underlying data. Accordingly, said filtering can occur for, and the system trained by, all data within the system, not just the underlying data.

The intermediary sender may inform said data owner after the data recipient is supplied the underlying data.

In a second aspect of the present invention, a computer implemented method supplying underlying data of a data owner to a data recipient via a sharing intermediary, said method comprising:
receiving, from a data recipient, a passphrase, said passphrase comprising a unique data identifier previously supplied by the sharing intermediary to the data owner, and uniquely associated with a set of underlying data of the data owner stored by the sharing intermediary;
requesting a confidence check of the data recipient, said confidence check comprising data confidence details previously supplied by the data owner of the underlying data; and
supplying said underlying data to the data recipient if the data confidence details match the data recipient supplying the passphrase.

According to a third aspect of the present invention, there is provided a system for undertaking the method according to any embodiment of the first or second aspect. Said system comprising a data server, said data server comprising said intermediary sender; a data communication device, said data communication device associated with the data owner; and a data terminal, said data terminal associated with the data recipient.

These and other aspects of the invention will be apparent from, and elucidated with reference to, the embodiments described hereinafter.

### BRIEF DESCRIPTION OF DRAWINGS

Embodiments will be described, by way of example only, with reference to the drawings, in which:

FIG. 1 is a simplified flowchart of part of the method according to the present invention;

FIG. 2 is a continuation of the flowchart of FIG. 1;

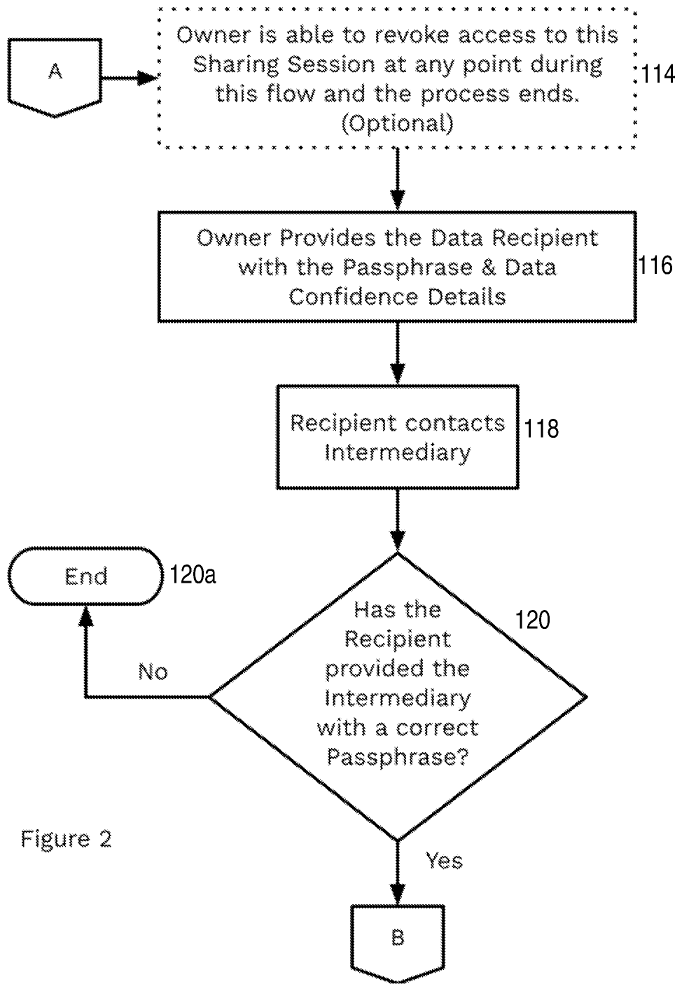

FIG. 3 is a further continuation of the flowchart of FIG. 2; and

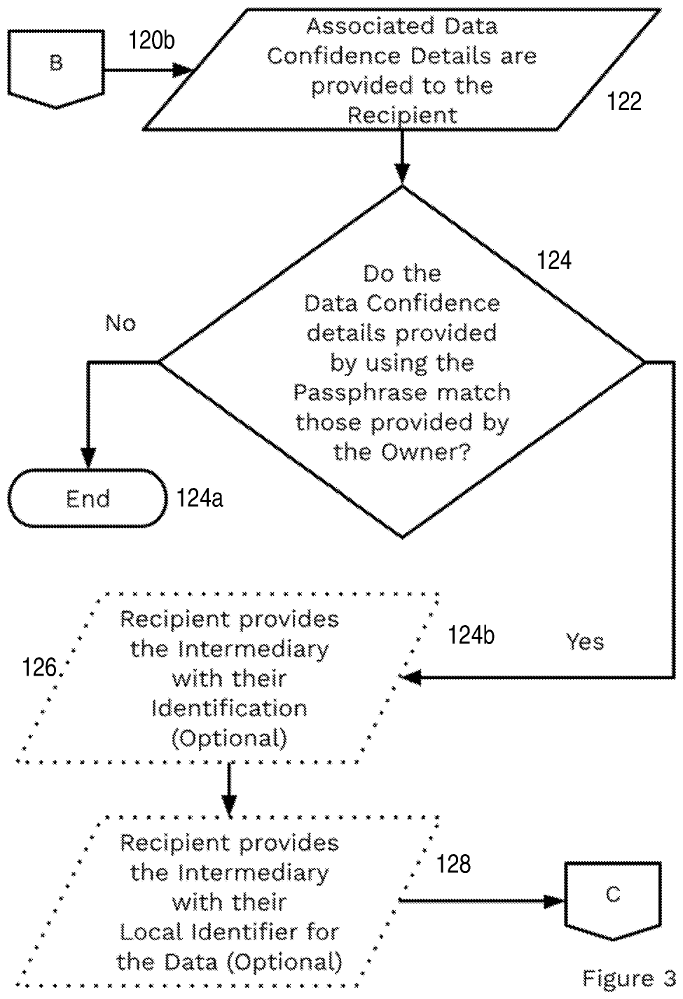

FIG. 4 is the final part of the flowchart continuing from FIG. 3.

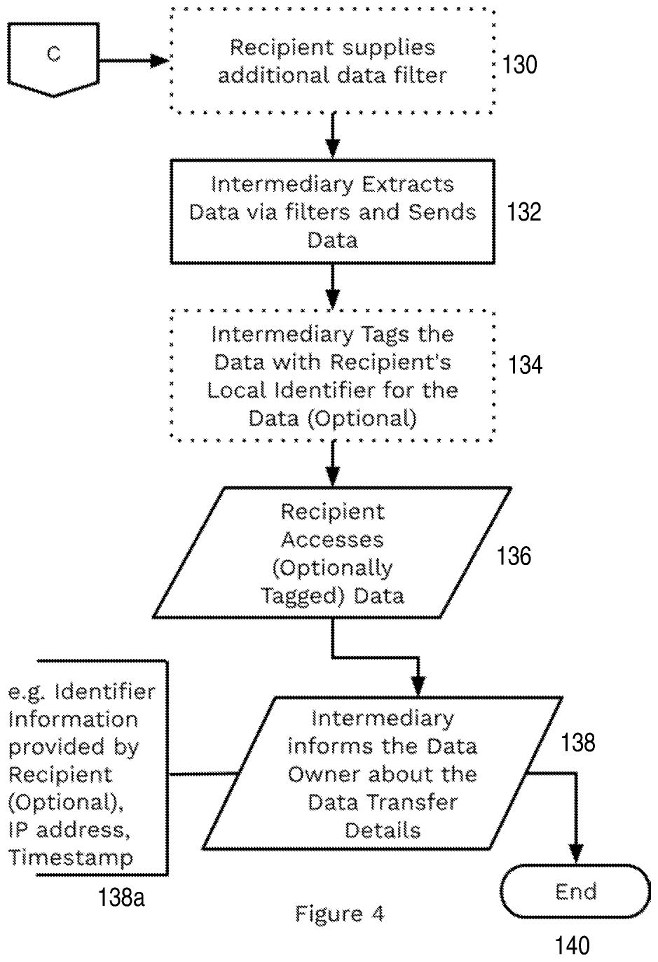

It should be noted that the Figures are diagrammatic and not drawn to scale. Relative dimensions and proportions of parts of these Figures have been shown exaggerated or reduced in size, for the sake of clarity and convenience in the drawings. The same reference signs are generally used to refer to corresponding or similar feature in modified and different embodiments.

### DETAILED DESCRIPTION OF EMBODIMENTS

Described herein is a method and system for sharing data securely from a data owner to a data recipient using a sharing intermediary.

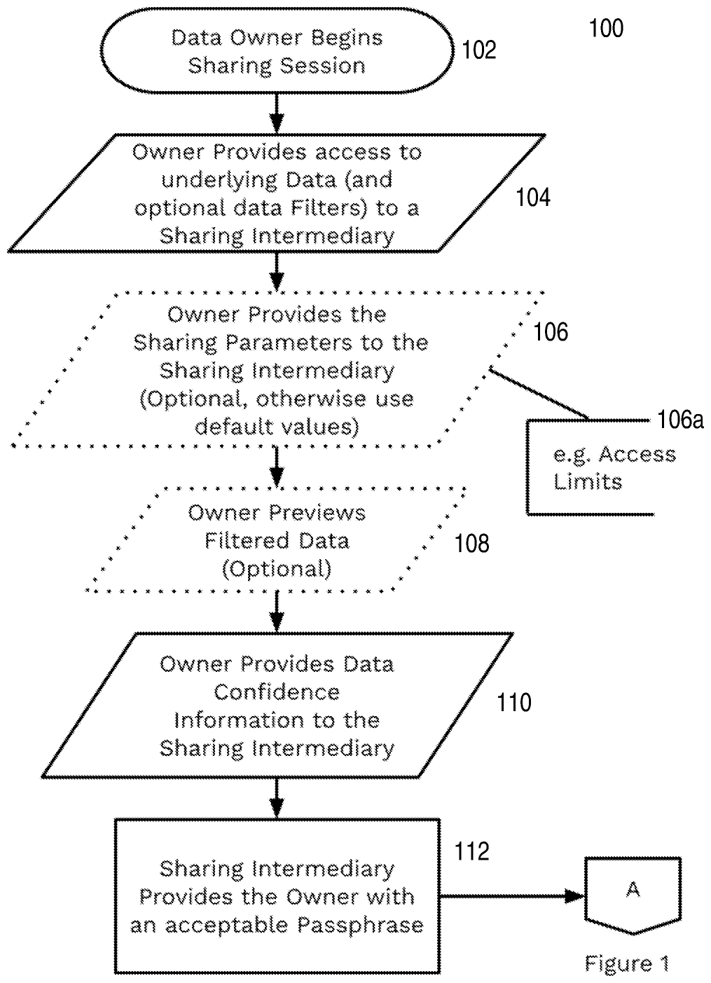

FIG. 1 shows a flowchart 100 according to an embodiment of the present invention. At step 102 a data owner, who has data stored on a data program on a data device (underlying data), such as within an app on a mobile phone, begins a sharing session with a data server using either the app or using another data program. At step 104, the owner provides access to the underlying data to a sharing intermediary such as a server. Data filters may be applied by the data owner to filter which information is shared with the sharing intermediary.

Typically the data owner provides parameters for the data to the sharing intermediary at step 106. These can include restrictions on the data use such as access limits 106a that can include a time limit before data expiry, a total number of times that the data can be accessed, etc.

At step 108, the data owner may be shown the data selected for provision to the sharing intermediary. It can be appreciated that the data may be stripped of identifiers—this may be done automatically by selecting fields with no metadata identifiers that could be used to identify a user and/or could be selected by the data owner. Examples of fields shared may include physiological and medical data such as height/weight/blood pressure or the like.

In step 110 the owner provides data confidence information to the sharing intermediary. Such data confidence information can include confirmation answers such as favourite colour or the like.

Once processed, the sharing intermediary then provides the owner with an acceptable passphrase in step 112. Such passphrase is typically a unique identifier generated using an algorithm in a similar manner to What3Words™. It should be noted that the data owner is able to revoke access to the below at any time 114.

When a data recipient requires the data, the data owner provides the data recipient the passphrase and data confidence details 116—for example, the data recipient may be a doctor such as a hospital doctor or a general practitioner. The data recipient then contacts the intermediary sharer 118 and supplies the intermediary sharer with the passphrase supplied by the data owner.

The intermediary sharer then checks whether the passphrase matches a stored passphrase 120. If not then the process ends 120a. If repeated attempts at the passphrase are detected then rather than stopping each attempt the system may optionally consider this an organised attack and may instead return randomly generated data. Valid users would still stop at the next stage because the data confidence question will fail. An attacker will then not be able to distinguish real data from spoof data making organised attacks more difficult. If a match is found 120b, then the intermediary sharer requests associated data confidence details to the data recipient 122. Such details can include the associated question matching the answer previously given by the data owner.

The data recipient then queries the data owner 124 to determine if the data confidence details match those associated with the passphrase provided by the data owner. If not, then the process ends 124a. If a match is found 124b then the data recipient may provide the intermediary with their identifying information 126. At this step, if the data owner 124 is a registered user, then the data recipients identifying information 126 may include meta data that is stamped onto the data record. This may be a manual step, or may occur automatically. Similarly the local identifiers and access passphrase may be similarly stored. This can allow the data recipient to refresh a record identified by the local identifier without re-entering the passphrase, but whilst retaining all other features of the system (such as revocations). The identified user may also request to be linked to a full unredacted record, and may also be provided write access. Such access requests would be pushed back to the user data owner, together with information about the data sharing session.

The recipient may then also provide the intermediary with local identifiers for the data 128—these can include local tags or the like. For example a general practitioner may use the data owner's medical number associated with their medical notes such that the incoming data is stored against their existing medical notes.

Similarly to the use of filters by the data owner, the data recipient may supply additional data filters on the underlying data to select which data they wish to access 130. The intermediary sender then extracts the desired and requested underlying data and sends this data to the data recipient 132. As noted, the data may be tagged by the intermediary with the recipient's local identifier for the underlying data 134. The recipient can then access the data 136.

It can be appreciated that the intermediary sender informs the data owner that the data recipient has successfully accessed and retrieved the stored data 138. Identifier information, akin to a digital access fingerprint, may be recorded by the intermediary to log access by the identified data recipient. Such information may include IP address, a timestamp, etc. Said log may include recording access on a blockchain rather than in a database. This may allow the distributed collection of data recipient information.

The present method allows for a data owner to allow a trusted data recipient to access data selected by the data owner that is automatically integrated into the data recipient's data record without the need for the data recipient to comply with data regulations. Given the data received from the intermediary sender is anonymized the data protection issues are simplified—there is no transfer of identifiable data. Instead the data owner supplies anonymous data to the intermediary sender who then supplies the anonymous data to the trusted data recipient who can then associate the data and re-personalise the data if authorised to do so by the data owner.

### Sending Service

Sending service/application asks the Data service/application to generate a passphrase. The sending service passes (most likely) anonymous data set to the Data service. The sending service can optionally set conditions (or stages to be completed) before seeing the data in the program (e.g. the sending service may give the Data Subject the option of setting an identity verification question—e.g. What is your favourite colour?). The sending service sets the limits on the service regarding the specific sent dataset (e.g. how often it can be viewed). The sending service can update the data sent to the program at any time (based on user options, e.g. update every time new information is entered or once a week).

### Sender/Data Subject

The Sender providers passphrase (and possibly the answer to the challenge question etc.) to the Receiver (a person) outside of the application (e.g. a patient gives details to their doctor over the phone).

### Data User (Data Receiver)

Receiver does not need to log into anything but simply enters the Passphrase into our website. The Passphrase optionally identifies the service provider being used by the Sender (only us at the moment but we plan to offer the service to 3rd party app providers). If the service provider is using verification question (or other form of ID check or other conditions) then instruction will follow now (e.g. “Your patient's favourite colour is Yellow. Where you expecting that answer?”). What happens next depends on the sender's service provider's instructions. The Receiver can request up to date data from the Sender.

Sending Service doesn't need to trust the Receiver (that is, they don't need to be a securely registered user). Receivers can only access the data if the Sender trusts them. The Receiver is responsible for keeping the passphrase secure.

Benefits to clinicians include quick and easy data retrieval. No integrations to get started. Secure transfers. Options to view or download a PDF for patient record. Benefits to patients are ease and speed of use. Data anonymization, only identified using secret information provided by the patient and that the patient can see who has accessed the data and can stop access to the data at any time.

From reading the present disclosure, other variations and modifications will be apparent to the skilled person. Such variations and modifications may involve equivalent and other features which are already known in the art of secure data transfer, and which may be used instead of, or in addition to, features already described herein.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination. The applicant hereby gives notice that new claims may be formulated to such features and/or combinations of such features during the prosecution of the present application or of any further application derived therefrom.

For the sake of completeness it is also stated that the term “comprising” does not exclude other elements or steps, the term “a” or “an” does not exclude a plurality, a single processor or other unit may fulfil the functions of several means recited in the claims and reference signs in the claims shall not be construed as limiting the scope of the claims.

1. A computer implemented method for securely sharing underlying data of a data owner to a data recipient, said method comprising:
providing access to the underlying data of the data owner to a sharing intermediary;
obtaining personalised data confidence information from the data owner and providing said personalised data confidence information to the sharing intermediary;
storing said underlying data and said personalised data confidence information at the sharing intermediary, wherein the personalised data confidence information is associated with the underlying data;
supplying a data passphrase generated by the sharing intermediary to the data owner, said data passphrase uniquely identifying said underlying data;
supplying the data passphrase and the data confidence information from the data owner to the data recipient;
providing the data passphrase and the data confidence information from the data recipient to the sharing intermediary;
checking, by the sharing intermediary, whether the data passphrase is associated with stored underlying data; and
supplying the underlying data from the sharing intermediary to the data recipient if the data confidence information matches the personalised data confidence information associated with the underlying data.

2. The method of claim 1, wherein the step of providing access to the underlying data of the data owner to a sharing intermediary further comprises the step of providing data filters, said data filters filtering said underlying data of the data owner provided to the sharing intermediary.

3. The method of claim 2, further comprising the step of providing a preview of the filtered underlying data to the data owner prior to providing said filtered underlying data to the sharing intermediary.

4. The method of claim 1, wherein the step of providing access to the underlying data of the data owner further comprises the step of anonymising the underlying data prior to providing access to the sharing intermediary.

5. The method of claim 1, wherein the step of providing access to the underlying data of the data owner further comprises the step of setting access limits on the underlying data.

6. The method of claim 1, further comprising the step of identifying the data recipient accessing the underlying data.

7. The method of claim 6, further comprising a step of logging identifier information of the data recipient against said underlying data after accessing said underlying data, to log the data access.

8. The method of claim 1, further comprising the step of supplying a local identifier of the data recipient for the underlying data to the sharing intermediary.

9. The method of claim 8, further comprising the step of tagging said underlying data with the data recipient's local identifier.

10. The method of claim 1, wherein the step of providing access to the underlying data of the data owner to a sharing intermediary further comprises the step of receiving an additional data filter from the data recipient, such that only underlying data corresponding to the additional data filter is supplied to the data recipient.

11. The method of claim 1, wherein the sharing intermediary informs said data owner after the data recipient is supplied the underlying data.

12. A computer implemented method supplying underlying data of a data owner to a data recipient via a sharing intermediary, said method comprising:
receiving, from a data recipient, a passphrase, said passphrase comprising a unique data identifier previously supplied by the sharing intermediary to the data owner, and uniquely associated with a set of underlying data of the data owner stored by the sharing intermediary;
requesting a confidence check of the data recipient, said confidence check comprising data confidence details previously supplied by the data owner of the underlying data; and
supplying said underlying data to the data recipient if the data confidence details match the data recipient supplying the passphrase.

13. A system for undertaking the method of claim 1, said system comprising a data server, said data server comprising said sharing intermediary; a data communication device, said data communication device associated with the data owner; and a data terminal, said data terminal associated with the data recipient.

14. The method of claim 1, wherein the step of providing access to the underlying data of the data owner further comprises the step of stripping the underlying data of identifiers that identify the data owner.

15. The method of claim 14, wherein the step of stripping the underlying data of identifiers comprises the step of selecting one or more fields within the underlying data that comprise no metadata identifiers that identify the data owner.

16. The method of claim 1, whereby if the data confidence information does not match the personalised data confidence information associated with the underlying data, then randomly generated data is supplied from the sharing intermediary to the data recipient.
